(19) United States
(12) Patent Application Publication
(10) Pub. No.: US 2008/0310825 A1
(43) Pub. Date: Dec. 18, 2008

(54) RECORD QUALITY BASED UPON NETWORK AND PLAYBACK DEVICE CAPABILITIES

(75) Inventors: Nicholas J. Fang, Redmond, WA (US); Ashley C. Speicher, Redmond, WA (US); Todd Bowra, Redmond, WA (US); Sudhakar V. Prabhu, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/761,501

(22) Filed: Jun. 12, 2007

(51) Int. Cl. H04N 7/26

(52) U.S. Cl. 386/124; 386/E05.003

(57) ABSTRACT

The recording of digital media according to one or more of playback device capabilities, network performance and user preference is disclosed. One embodiment provides a method for recording digital video comprising determining a first set of capabilities of a first networked playback device, receiving media in at least one of a first format and a first bit rate, and recording the media in at least one of a second format and a second bit rate according to the first set of capabilities. In this manner, playback considerations may be incorporated while the digital media is recorded, thus improving the playback of the digital media at a later time.

### BACKGROUND

As computing and communication networks continue to evolve, media is increasingly being stored, processed, and used digitally. Communication, networking, and device capabilities may vary significantly in these networks. For example, digital media may be encoded in different formats, transmitted at different bit rates, stored at varying compression levels, etc. When digital media is used or transmitted between devices with different capabilities, or over networks with limited capabilities, the quality of the playback experience is often compromised.

Digital video recorders (DVRs) that support streaming of recorded media to network nodes are becoming increasingly common. DVRs receive an input video signal and store it in memory according to a certain encoding format and bit rate, and time-shift the recorded media so a user may watch it at a later time. Currently, DVRs base recording quality only on factors local to the digital video recording device, such as hard drive storage space. However, when media is sent through a network, media playback can be affected when the media is streamed across a limited bandwidth link or when the media is sent to a device with different capabilities than those required to play back the media as stored on the hard drive. Current approaches attempt to address these issues in real time during media playback and can therefore be resource intensive, cause latency, decrease media playback quality, cause additional problems when multiple playback devices are used, and in general provide an unsatisfactory end user experience.

### SUMMARY

Accordingly, an improved method for recording digital media according to one or more of playback device capabilities, network performance, and user preference is described below in the Detailed Description. For example, one disclosed embodiment provides a method for recording digital video comprising determining a first set of capabilities of a first networked playback device, receiving media in at least one of a first format and a first bit rate, and recording the media in at least one of a second format and a second bit rate according to the first set of capabilities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of an embodiment of a home media environment.

FIG. 2 shows a block diagram of a media server and a media receiver of the embodiment of FIG. 1.

FIG. 3 shows a process flow of an embodiment of a method for determining recording quality based upon networked device capabilities.

### DETAILED DESCRIPTION

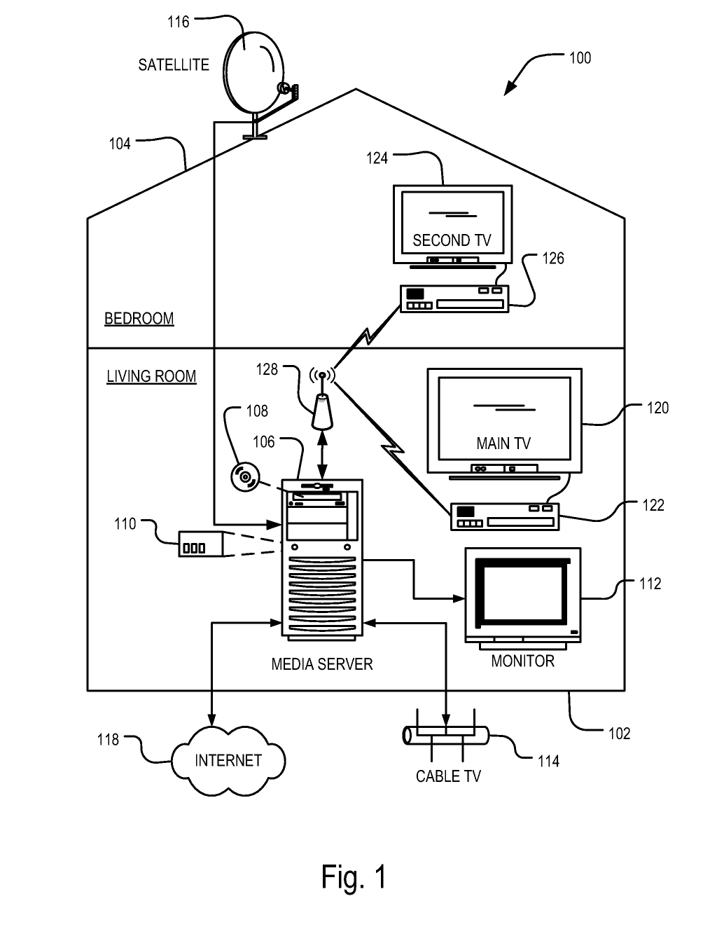

Prior to discussing adjusting recording quality based upon network and playback device capabilities, one embodiment of a streaming media use environment is described. FIG. 1 depicts an exemplary home entertainment environment 100 including a living room 102 and a bedroom 104. Central to the home entertainment environment 100 is a media server 106, in this implementation situated in the living room 102, but which could be located anywhere within the house or in communication with devices in the house through a network 128. In one implementation, the media server 106 is a conventional personal computer (PC) configured to run a multimedia software package, for example, the Windows Vista Ultimate operating system with Windows Media Center (available from Microsoft Corporation of Redmond, Wash.). In such a configuration, the media server 106 is able to integrate full computing functionality with a complete home entertainment system into a single PC. For example, a user can watch television (TV) in one graphical window of an attached video monitor 112, while sending e-mail or working on a spreadsheet in another graphical window on the same monitor 112. In addition, the media server 106 may also include other features or components, for example: a digital video recorder (DVR) to capture video content for future viewing or to record the future broadcast of a single program or series; a compact disc (CD) or digital video disc (DVD) drive 108 for disc media playback; a memory drive 110 for integrated storage of and access to a user's recorded content, such as TV shows, songs, pictures, data, media, and home videos; and an electronic program guide (EPG) (not shown in FIG. 1).

Instead of a conventional PC, the media server 106 may comprise a variety of other devices capable of storing and distributing media content including, for example, a notebook or portable computer, a tablet PC, a workstation, a mainframe computer, a server, an Internet appliance, a DVR, or combinations thereof. The media server 106 may also be a set-top box capable of delivering media content to a computer where it may be streamed, or the set-top box itself could stream the media content. As the media server 106 may be a full function computer running an operating system, the user may also have the option to run standard computer programs (e.g., word processing and spreadsheets), send and receive e-mails, browse the Internet, or perform other functions.

In addition to storing media content, the media server 106 may be connected with a variety of media sources, for example, a cable connection 114, a satellite receiver 116, an antenna (not shown), and/or a network such as the Internet 118. A user may thus control a live stream of media content (e.g., TV content) received, for example, via the cable connection 114, the satellite receiver 116, or antenna. This capability may be enabled by one or more tuners residing in the media server 106. The one or more tuners may alternatively be located remote from the media server 106. In either case, the user may choose a tuner to fit any particular preferences. For example, a user wishing to watch both standard definition (SD) and high definition (HD) content may employ a tuner configured for both types of content. Alternately, the user may employ an SD tuner for SD content and an HD tuner for HD content separately.

The TV content may be received as an analog (i.e., radio frequency) signal or a digital signal (e.g., digital cable). The received TV content may include discrete content packets, where each content packet includes actual TV content (i.e., audio and video data) and a policy or policies associated with the actual TV content. If TV content is received as an analog signal, discrete content packets may be created from the analog signal.

The entertainment environment 100 may also include one or more network devices functioning as media receivers 122, 126, sometimes referred to as a network node, placed in communication with the media server 106 through a network 128 such as a local area network (LAN). In an exemplary embodiment, each media receiver 122, 126 may be a Media Center Extender device, for example, an Xbox 360™ (Microsoft Corporation, Redmond, Wash.). The media receivers 122, 126 may also be implemented as any of a variety of conventional media rendering or computing devices, including, for example, a set-top box, a television, a video gaming console, a desktop PC, a notebook or portable computer, a workstation, a mainframe computer, an Internet appliance, a handheld PC, a cellular telephone or other wireless communications device, a personal digital assistant (PDA), a network capable device, or combinations thereof. Furthermore, the media receivers 122, 126 may include a tuner as described above.

The network 128 may comprise a wired and/or wireless network, for example, cable, Ethernet, WiFi, a wireless access point (WAP), or any other electronic, radio frequency or optical coupling means, including the Internet. The network 128 may enable communication between the media server 106, the media receivers 122 and 126, and any other connected device through packet-based communication protocols, such as Transmission Control Protocol (TCP), Internet Protocol (IP), Real-time Transport Protocol (RTP), User Datagram Protocol (UDP) and Real-time Transport Control Protocol (RTCP), or other packet based communication protocols, as examples. Communications may be transmitted directly between devices over a LAN, or they may be carried over a wide area network (WAN), for example, the Internet 118.

Entertainment environment 100 may include one or more video display devices, for example a main TV 120 in the living room 102, a secondary TV 124 in the bedroom 104, and a video monitor 112 in the entertainment environment 100. These video display devices may be connected with the media server 106 via the network 128 either directly or via the media receivers 122, 126. As shown in the example of FIG. 1, the main TV 120 and the secondary TV 124 may be coupled to the media receivers 122, 126 through conventional cables. The video monitor 112 may be coupled with the media server 106 directly via a video cable. The media server 106 and media receivers 122, 126 may alternatively be coupled with any of a variety of video and audio presentation devices and by other couplings than conventional cables. Media content including TV content may thus be supplied to each of the video display devices 112, 120, 124 over the home network 128 from the media server 106 situated in the living room 104.

The media receivers 122, 126 may be configured to receive streamed media content, including video and TV content, from the media server 106. Media content, and particularly video and TV content, may be transmitted from the media server 106 to the media receivers 122, 126 as streaming media comprised of discrete content packets via the network protocols described above, or even other network protocols. The streamed media content may comprise IPTV (television content delivered over the Internet), SD, and HD content, including video, audio, and image files, decoded on the media receivers 122, 126 for presentation on the connected TVs 120, 124 or monitor 112. The media content may further be “mixed” with additional content, for example, an EPG, presentation content related to the media content, a web browser window, and other user interface environments transmitted from the media server for output on the TVs 120, 124 or the monitor 112. Such additional media content may be delivered in a variety of ways using different protocols, including, for example, standard Remote Desktop Protocol (RDP), Graphics Device Interface (GDI), Hypertext Markup Language (HTML), or other protocols providing similar functionality.

In addition to the media receivers 122, 126 and the video display devices 112, 120, 124, the media server 106 may be connected with other peripheral devices, including components such as a DVR, cable or satellite set-top boxes, speakers, a printer (not shown), etc. The media server 106 and/or media receivers 122, 126 may also enable multi-channel output for speakers. This may be accomplished through the use of digital interconnect outputs, such as Sony-Philips Digital Interface Format (S/PDIF) or TOSLINK® enabling the delivery of Dolby Digital, Digital Theater Sound (DTS), or Pulse Code Modulation (PCM).

Prior to discussing these embodiments in detail, it will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. The term “program” as used herein may connote a single program or multiple programs acting in concert, and may be used to denote applications, services, or any other type or class of program. Likewise, the terms “computer” and “computing device” as used herein include any device that electronically executes one or more programs stored in memory, including but not limited to media server 106, media receivers 122, 126, and any other suitable device such as personal computers, servers, laptop computers, hand-held devices, cellular phones, microprocessor-based programmable consumer electronics and/or appliances, routers, gateways, hubs, and other computer networking devices.

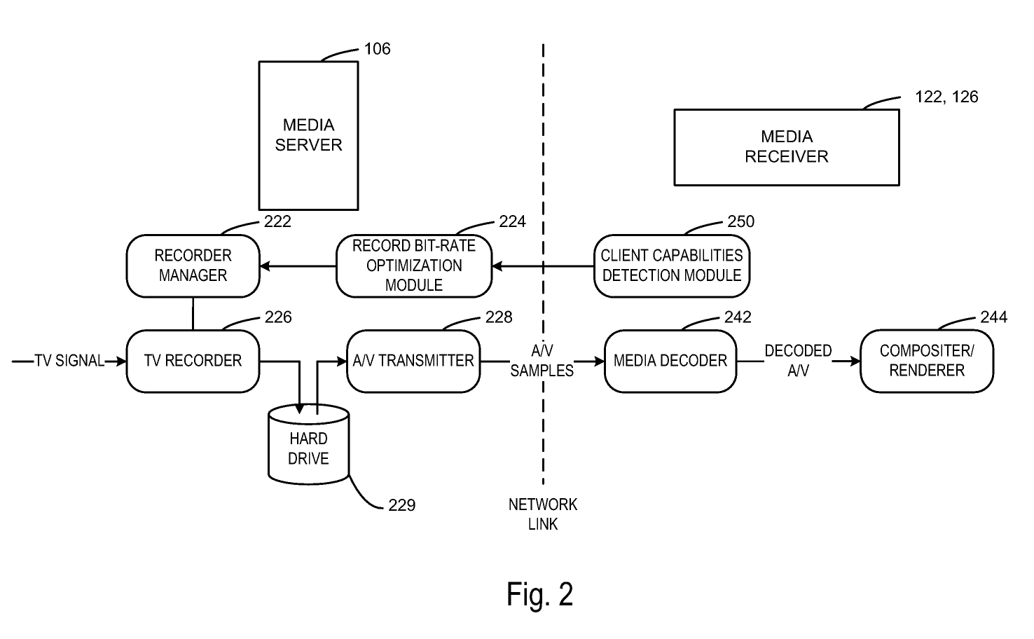

FIG. 2 shows a block diagram of a media server 106 and a media receiver 122, 126 of the embodiment entertainment environment 100 of FIG. 1. In one embodiment, media server 106 includes a TV recorder 226 that receives an input TV signal and stores the signal in digital format. Other embodiments may receive other types of media signals and record the media signals with media recording devices similar to TV recorder 226.

The TV signal may be an analog or a digital signal. If the TV signal is originally in an analog format, a capture device (not shown) may receive the analog signal and convert it to a digital format for TV recorder 226 to record. Example analog signals include cable or broadcast NTSC television signals and example digital formats include Motion Picture Experts Group 2 (MPEG-2), ITU standard H.264, Windows Media Video (WMV), etc. In addition to different digital formats, digital video may also be saved at different bit rates. For example, digital video may be in the MPEG-2 format at a 20 megabit per second (Mbit/s) bit rate.

According to the embodiment shown in FIG. 2, media server 106 records digital video in a certain format and bit rate onto hard drive 229 using TV recorder 226. At playback time, audio/video (A/V) transmitter 228 then receives the stored digital video and sends A/V samples over a network link to media receiver 122 or 126. For example, the A/V samples may be sent using a network streaming protocol such as RTP over UDP datagrams. In the present embodiment, media receiver 122 or 126 receives the A/V samples at media decoder 242, although there may be other functional blocks in the input stream of A/V samples before media decoder 242. For example, a buffer (not shown) may receive the A/V samples. Media decoder 242 decodes the received A/V samples and sends the raw video to a video compositer/renderer 244, which renders the video for display on a device such as monitor 112, or TVs 120 and 124 from FIG. 1.

The present embodiment illustrates A/V samples being sent from A/V transmitter 228 to media decoder 242, but other embodiments are not so limited. For example, one of the audio or video media may be sent absent the other and still fall within the principles of this disclosure. Compositer/renderer 244 may also send audio to a sound card or other presentation device. FIG. 2 illustrates the components of a single media receiver 122, but other embodiments may comprise multiple media receivers including similar components as those illustrated in FIG. 2. As an example, FIG. 1 depicts media server 106 coupled to media receiver 122 and media receiver 126 through network 128.

Referring back to FIG. 2, a home DVR conventionally sets recording quality (for example, a specific digital format and bit rate) according to characteristics of the recording device itself, for example according to the available hard drive storage space of the DVR. This approach can be problematic for at least the reasons discussed above.

To overcome these problems, an embodiment of a TV recorder 226 may use a multitude of sources or items of information, in addition to hard drive storage space of the DVR itself, to determine the quality or format in which to record digital media. For example, an embodiment may consider supported media formats on the media receiver, a supported bit rate, usage/playback statistics, receive buffer fullness, playback quality statistics, network connection performance, and playback device hardware capabilities, etc., to determine parameters of recorded media that improve playback quality. In this way, media may be transmitted over the network with less real-time correction, such as transrating or transcoding, which can degrade the experience for the end user when the media is played at a media receiver 122 or displayed on TV 120 in FIG. 1.

In FIG. 2 an embodiment using media receiver 122 is described, although similar embodiments using media receiver 126, or other combinations of media receivers are also within the subject matter of this disclosure. Media receiver 122 is illustrated comprising a client capabilities detection module 250. Client capabilities detection module 250 determines supported digital media characteristics such as bit rate and digital formats, and reports the capabilities of media receiver 122 over a network link to record bit rate optimization module 224 in media server 106. Other example client capabilities detected by client capabilities module 250 may include hardware limitations of the media receiver, such as bus bandwidth limitations, CPU speed, limitations of graphics or decoding hardware, etc. In alternate embodiments, client capabilities detection module 250 may reside in a separate device from the media receiver, such as another networked device, or even in media server 106. Functionally, client capabilities detection module 250 determines or reads from a memory location the capabilities of media receiver 122, and this may be done remotely, or as an integrated unit in any media receiver 122 or other network node.

In other embodiments, record bit rate optimization module 224 may receive other capabilities such as supported digital formats, or may not actually optimize but may just use capabilities to determine recording characteristics, etc. In the present example, record bit rate optimization module 224 provides the client capabilities to recorder manager 222, and recorder manager 222 then communicates with TV recorder 226 so that incoming media is recorded on hard drive 229 according to supported or preferred device capabilities. Record bit rate optimization module 224 may also receive inputs from sources other than client capabilities detection module 250 and recorder manager 222 can consider these extra inputs to adjust recording quality. It is within the scope of this disclosure to have the components illustrated in FIG. 2 distributed in another arrangement, and the embodiment of FIG. 2 is only to provide a non-limiting illustrative example.

In yet another embodiment, the digital media can be recorded according to capabilities detected once the network is operational. For example, multiple test streams may be sent from media server 106 to media receiver 122, and a component can determine which stream performed better. The component may observe media playback for quality or can use statistics gathered during playback regarding whether the media buffers are starving and/or flooded, whether audio or video is glitching, whether the network capacity is being overwhelmed, and other such characteristics. In another embodiment, a user may view the streams and select a preferred stream, and the test mode can end and the digital media can be recorded according to the selected preferred stream characteristics.

Some embodiments may individually select a preferred recording bit rate or a preferred recording format. Other embodiments may adjust other recording parameters based upon network performance, media receiver or playback capabilities, user settings, or other inputs or performance parameters that are capable of being selected, measured, adjusted, etc. In one example, an embodiment may adjust recording parameters based upon network nodes that are more often used, such as a main TV 120, or based upon network nodes in a certain location such as in a living room 102. Other examples may allow a user to specify a primary TV and weight recording parameters in preference of particular network nodes and connected devices. Additionally, other embodiments may dynamically adjust recording parameters in response to concurrent real-time playback. In another multiple node or multiple media receiver configuration, an embodiment system may set recording parameters, such as digital format and bit rate, according to a commonly supported digital format or bit rate over each of the media receivers, for example, a lowest common denominator setting to ensure that the media can play back satisfactorily on any of the connected networked media receivers or display devices.

Some embodiments may detect changes in connected devices, such as changing device capabilities, devices added to or subtracted from the entertainment environment 100, changes in network performance, etc., and can adjust recording capabilities according to these detected changes. In yet another embodiment, device capabilities can be stored so that a device may be disconnected and reconnected to entertainment environment 100 and capabilities of that device can be considered without having to re-detect the device's capabilities using client capabilities detection module 250.

Some embodiments may employ a scalable codec to effectively record at multiple bit rates to allow playback at two media receivers 122 and 126 at different rates. In this example, if the respective client capabilities detection module 250 in media receiver 122 provides a different set of capabilities than client capabilities detection module 250 in media receiver 126, then recorder manager 222 can record an incoming TV signal in a scalable codec. The present embodiment allows different playback at two different media receivers. In an alternate embodiment, a TV recorder 226 with multiple tuners may be instructed by recorder manager 222 to use a first tuner to record the incoming TV signal at a different quality level than the second tuner, which also records the incoming TV signal. Additionally, in embodiments that record with a scalable codec, with multiple tuners, or otherwise record redundantly, as network or playback quality changes, A/V transmitter 228 can dynamically select the appropriately recorded digital media to improve playback quality.

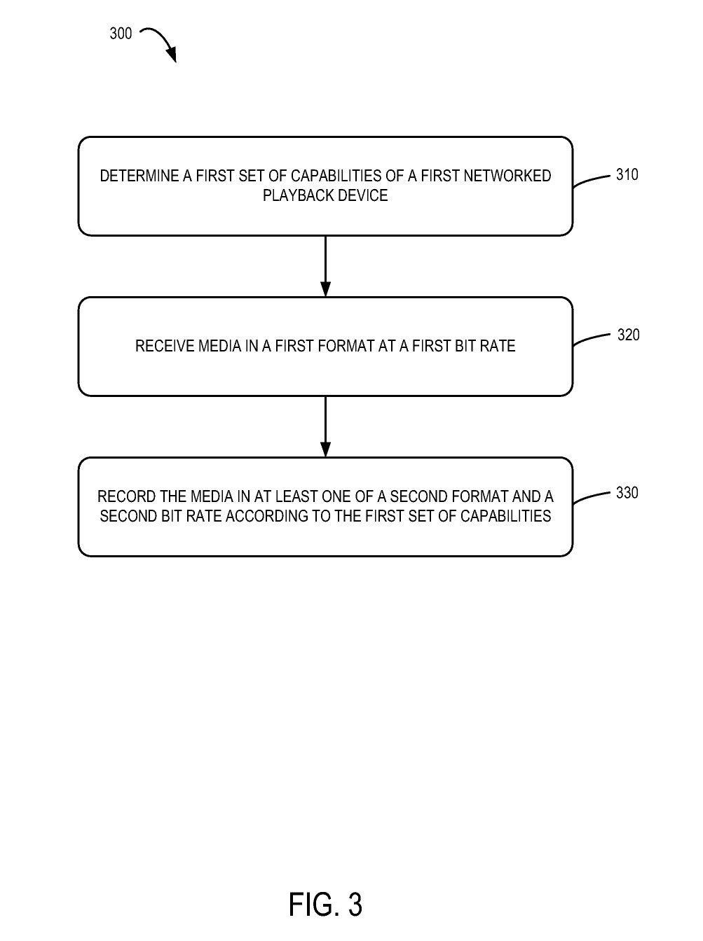

FIG. 3 shows a process flow of an embodiment of a method 300 for determining recording quality based upon networked device capabilities. Method 300 determines a first set of capabilities of a first networked playback device in block 310. As explained above, the networked device may be a media receiver, display device, or other such device. Additionally, the first set of capabilities of the device may include any of supported media formats, supported bit rates, usage statistics, buffer fullness statistics, playback quality statistics, network connection performance, and hardware capabilities of the playback device, as examples. In block 320, the method receives media in a first format at a first bit rate. An example format and bit rate is MPEG-2 at 20 Mbit/s. In block 330, method 300 then records the received media in at least one of a second format and a second bit rate according to the first set of capabilities determined in block 310. In some embodiments, method 300 determines recording quality based upon the capabilities of multiple devices. For example, method 300 may determine capabilities for multiple devices and record received media according to the capabilities of the multiple devices. Other embodiment methods may comprise a process implementing other embodiment systems or devices in this disclosure.

While described herein in the context of a home streaming media environment, it will be appreciated that the concepts disclosed herein may be used in any suitable streaming media environment, including but not limited to other client-server-based use environments and peer-to-peer-based use environments. Furthermore, while the media server and media receiver are shown herein as being located on different devices, it will be understood that these components may comprise separate components, modules, programs or other entities running on a single device.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A method of recording digital video, the method comprising:
determining a first set of capabilities of a first networked playback device;
receiving media in at least one of a first format and a first bit rate; and
recording the media in at least one of a second format and a second bit rate according to the first set of capabilities.

2. The method of claim 1, wherein the first set of capabilities includes at least one of a supported media format, a supported bit rate, usage statistics, playback quality statistics, network connection performance, and hardware capabilities of the first networked playback device.

3. The method of claim 1, further comprising determining a second set of capabilities of a second networked playback device.

4. The method of claim 3, wherein the second set of capabilities includes at least one of supported media format, supported bit rate, usage statistics, playback quality statistics, network connection performance, and hardware capabilities of the second networked playback device.

5. The method of claim 3, further comprising recording the media in at least one of a second format and a second bit rate according to the first set of capabilities and the second set of capabilities.

6. The method of claim 5, wherein recording the media according to the first set of capabilities and the second set of capabilities includes selecting a commonly supported format or bit rate of the first and second playback devices.

7. The method of claim 5, further comprising:
selecting a preferred format or bit rate according to at least one of a user preference, playback device usage, and playback device capabilities of the first and second playback devices; and
recording the media according to the preferred format or bit rate.

8. The method of claim 5, further comprising recording the media using a scalable codec or multiple tuners according to playback device capabilities, to allow playback of multiple versions of the media.

9. A system, comprising:
a first playback device;
a client capabilities detection module configured to determine a first set of capabilities of the first playback device; and
a digital media recorder networked with the first playback device and in communication with the client capabilities detection module, the digital media recorder to receive media in at least one of a first format and a first bit rate, and to record the media in at least one of a second format and a second bit rate according to the first set of capabilities of the first networked playback device.

10. The system of claim 9, wherein the digital media recorder is a digital video recorder.

11. The system of claim 9, wherein the first set of capabilities includes at least one of a supported media format, a supported bit rate, usage statistics, playback quality statistics, network connection performance, and playback device hardware capabilities.

12. The system of claim 9, further comprising a second playback device, wherein the client capabilities detection module is configured to determine a second set of capabilities of the second playback device, wherein the second set of capabilities includes at least one of a supported media format, a supported bit rate, usage statistics, playback quality statistics, network connection performance, and playback device hardware capabilities.

13. The system of claim 12, wherein the digital media recorder is to record the media in at least one of a second format and a second bit rate according to the first set of capabilities and the second set of capabilities.

14. The system of claim 9, wherein the media is recorded according to a commonly supported format or bit rate of the first and second playback devices.

15. The system of claim 9, wherein the media is recorded according to a preferred format or bit rate, wherein the preferred format or bit rate is selected by at least one of a user preference, playback device usage, and playback device capabilities.

16. The system of claim 9, wherein the digital media recorder is configured to record the media with a scalable codec or with multiple tuners according to the first and second playback device capabilities, to allow playback of multiple versions of the media.

17. A computing device, comprising:
memory;
a processor; and
instructions stored in memory and executable by the processor to determine capabilities of at least one networked playback device, to receive media in at least one of a first format and a first bit rate, and to record the media in at least one of a second format and a second bit rate according to the capabilities of the at least one networked playback device, wherein the capabilities include at least one of a supported media format, a supported bit rate, usage statistics, buffer fullness, network connection performance, and hardware capabilities of the networked playback device.

18. The computing device of claim 17, wherein the media is recorded according to a commonly supported format or bit rate of a plurality of networked playback devices.

19. The computing device of claim 17, further comprising instructions to select a preferred format or bit rate according to at least one of a user preference, playback device usage, and playback device capabilities of a plurality of playback devices, and instructions to record the media according to the preferred format or bit rate.

20. The computing device of claim 17, further comprising instructions to record the media using a scalable codec or multiple tuners according to playback device capabilities, to allow playback of multiple versions of the media.
